(19) United States
(12) Patent Application Publication
(10) Pub. No.: US 2007/0146938 A1
(43) Pub. Date: Jun. 28, 2007

(54) Head arm and information storage apparatus

(75) Inventor: Kaoru Abiko, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/385,475

(22) Filed: Mar. 21, 2006

(30) Foreign Application Priority Data
Dec. 27, 2005 (JP) 2005-375264

(51) Int. Cl. G11B 5/55

(52) U.S. Cl. 360/264.2

(57) ABSTRACT

A head arm holds a head that accesses information on the information recording medium and includes: a metal plate that plays at least part of a role of holding the head; and a lead unit, provided on the metal plate, electrically connected to the head, and through which a signal representing the information passes. The lead unit has a conductive wire section, mounted on the metal plate, where conductive wires including a first signal conductive wire through which a current corresponding to the signal heads for the head and a second signal conductive wire through which the current corresponding to the signal returns from the head are laminated. The first and second signal conductive wires are situated symmetrically with each other in the lamination direction. The lead unit also has a ground line, situated on the conductive wire section, whose electrical potential is equal to that of the metal plate.

### BACKGROUND OF THE INVENTION

1. Field of the Invention

The present invention relates to a head arm that holds a head for accessing informational on an information recording medium, and to an information storage apparatus in which information is stored in the information recording medium.

2. Description of the Related Art

To date, as an information storage apparatus incorporated in or connected to an electronic apparatus such as a personal computer or a word processor, a hard disc drive (HDD) in which information is magnetically stored in a magnetic disc (hard disc), an MO disc apparatus in which information is optically and magnetically stored in a magneto-optical (MO) disc, and the like are known.

In general, an HDD is equipped with a magnetic disc as an information recording medium and a magnetic head that reads recording pits from and writes recording pits in the magnetic disc; the HDD is equipped also with a slider on which the magnetic head is mounted, a head arm that holds the slider in the vicinity of the magnetic disc, and an actuator that moves the magnetic head along the magnetic disc, by driving the head arm.

With advance of a personal computer and the like, the recording density of a hard disc drive has been increased; in recent years in particular, the recording density has been drastically increasing, while demand for dealing with images and music by means of a personal computer or the like has been being raised. Moreover, with increase in the recording density of a hard disc drive, recording pits on the magnetic disc have been made extremely fine, and the rotating speed of a disc has been increased, whereby request for accuracy enhancement and speedup of magnetic-head positioning has been raised. In addition, enhancement of production-friendliness and downsizing are also strongly requested.

In order to respond to the foregoing requests, techniques have been proposed in which, by contriving details of the head arm of a hard disc drive, accuracy enhancement and speedup of magnetic-head positioning is achieved. For instance, in Japanese Patent Application Laid-Open No. 1987-279570 and Japanese Utility Model Laid-Open No. 1989-177473, a technique is disclosed in which, by bending the edge portion of a leaf-spring-like suspension incorporated in an actuator that holds a slider, vibration is reduced in the case where outer force is applied to the head arm. Moreover, in Japanese Laid-Open Patent Publication No. 1998-116409, a technique is disclosed in which, as leading wires (a lead unit) that are connected to a magnetic head mounted on a slider and through each of which a recording signal or a reproduction signal passes, a lead unit is employed in which conductive wires are arranged in parallel on a metal plate, instead of wire-lead unit in which each of conductive wires is separated from one another.

Still moreover, in recent years, a technique has been developed in which, by embedding a heating element in a magnetic head and applying a current to the heating element to heat the magnetic head, the portion, of a slider, on which the magnetic head is mounted is made to protrude through thermal expansion, whereby the magnetic head is made to be situated in the vicinity of a magnetic disc. It is expected that the particular technique miniaturizes recording pits to be read and written by the magnetic head; however, with regard to conductive wires connected to the magnetic head, in contrast to a conventional technique in which totally four conductive wires consisting of two each for recording and reproducing are provided, totally six conductive wires including two additional conductive wires for heating are required. Accordingly, with regard to the lead unit in which, as disclosed in Japanese Laid-Open Patent Publication No. 1998-116409, conductive wires are arranged in parallel, it is difficult to ensure a space for integrating the lead unit, and the lead unit vibrates through agitation by a wind caused by the rotation of the magnetic disc, thereby adversely effecting the accuracy of head positioning, which is problem.

In order to cope with the problem, in Japanese Laid-Open Patent Publication No. 1997-22570, a technique is disclosed in which a lead unit formed of laminated conductive wires is utilized; it is conceivable that the particular technique ensures the space and reduces the agitation by the wind.

Meanwhile, in order to avoid in-bound magnetic noise, each of a recording signal and a reproduction signal that pass through the lead unit is normally a differential signal between a current signal that heads for the magnetic head and a current signal that returns from the magnetic head; however, in the lead unit in which, as disclosed in Japanese Laid-Open Patent Publication No. 1997-22570, conductive wires are laminated, it has been a problem that, because respective impedances of the laminated conductive wires are different, and the difference causes difference values between the respective signals that pass the corresponding conductive wires, the differential signals are rendered inaccurate, thereby adversely effecting the recording and reproducing of information.

The foregoing problems is not a problem that occurs only with an HDD, but a problem that generally occurs with a type of an information storage apparatus in which a recording signal and a reproduction signal pass through a lead unit mounted on a head arm.

### SUMMARY OF THE INVENTION

The present invention has been made in view of the above circumstances and provides a head arm and an information storage apparatus that are downsized and high-accuracy.

The present invention provides a head arm that, in vicinity or in contact with an information recording medium, holds a head that accesses information on the information recording medium, the head arm including:

a metal plate that plays at least part of a role of holding the head; and

a lead unit, provided on the metal plate, that is electrically connected to the head and through which a signal representing the information passes, the lead unit having a conductive wire section, mounted on the metal plate, in which a plurality of conductive wires including a first signal conductive wire through which a current corresponding to the signal heads for the head and a second signal conductive wire through which the current corresponding to the signal returns from the head are laminated and the first signal conductive wire and the second signal conductive wire are situated symmetrically with each other, in the direction of the lamination, and the lead unit having a ground line, situated on the conductive wire section, whose electrical potential is the same as that of the metal plate.

In a head arm according to the present invention, the electric arrangement environment around the first signal conductive wire is equivalent, including the metal plate on which the lead unit is mounted, to that around the second signal conductive wire, and the respective impedances of the signal conductive wires are equal to each other; therefore, the accuracy of the differential signals is high, whereby the accuracy in recording and/or reproducing of information is also high. Moreover, because a lead unit including laminated conductive wires is utilized, the mounting area for the lead unit is small, thereby enabling the head arm to be downsized and the effect of agitation by a wind to be reduced, whereby the accuracy in positioning of the head is high.

It is preferable that, in the head arm according to the invention, the head records information in and reproduces information from the storage medium, and

the head further includes, as the lead units, a recording lead unit through which a recording signal representing recording information passes and a reproducing lead unit through which a reproducing signal representing reproducing information passes.

Because, in the case where both a conductive wire through which a recording signal passes and a conductive wire through which a reproducing signal passes are laminated in a single lead unit, the distance between the conductive wires is small and the signals interfere with each other, whereby the accuracy in positioning of the head may be deteriorated; therefore, it is preferable to provide a recording lead unit through which the recording signal passes and a reproducing lead unit through which the reproducing signal passes.

It is preferable that, in the head arm according to the invention, the head has a function of approaching the information recording medium, by being heated through an electric current, thereby being deformed, and the conductive wire section of the lead unit is configured such that a heating conductive wire through which an electric current for deforming the head passes is laminated interposed between the first signal conductive wire and the second signal conductive wire.

As described above, in recent years, a head having a function of being deformed through heating has been proposed, whereby a conductive wire has been required through which an electric current utilized for the function passes.

In a head arm, having the heating conductive wire, according to the above additional feature, the existence of the heating conductive wire equally effects the respective impedances of the first signal conductive wire and the second signal conductive wire; therefore, without adversely effecting recording and reproducing of information, the heating conductive wire can be introduced in a space-saving fashion.

The present invention also provides an information storage apparatus including:

a medium holding section that holds a predetermined information recording medium;

a head that accesses information on the information recording medium;

a head arm that holds a head, in a vicinity or in contact with the information recording medium, the head arm including:

a metal plate that plays at least part of a role of holding the head;

a lead unit, provided on the metal plate, that is electrically connected to the head and through which a signal representing the information passes, the lead unit having a conductive wire section, mounted on the metal plate, in which a plurality of conductive wires including a first signal conductive wire through which a current corresponding to the signal heads for the head and a second signal conductive wire through which the current corresponding to the signal returns from the head are laminated and the first signal conductive wire and the second signal conductive wire are situated symmetrically with each other, in the direction of the lamination, and the lead unit having a ground line, situated on the conductive wire section, whose electrical potential is the same as that of the metal plate; and

a drive section that drives the head arm such that the head moves along the top side of the information recording medium.

The head arm provided in an information storage apparatus according to the present invention is highly accurate, as described above; therefore, the information storage apparatus itself is highly accurate and enabled to conform to enhancement in information density and information speed. Moreover, as described above, the head arm provided in the information storage apparatus is enabled to be downsized and less susceptible to agitation by a wind; therefore, it is possible to employ a small-sized recording medium and to arrange recording media spaced close to one another, whereby the entire information storage apparatus is readily downsized.

In addition, for an information storage apparatus according to the present invention, only a basic mode is described herein; however, that is just because duplicate descriptions should be avoided, and in an information storage apparatus according to the present invention, not only the basic mode but also respective kinds of modes corresponding to the head arms are included.

As described heretofore, according to the present invention, a downsized and high-accuracy head arm and an information storage apparatus can be obtained.

### BRIEF DESCRIPTION OF THE DRAWINGS

FIG. 1 is a view illustrating an embodiment of the present invention;

FIG. 2 is an enlarged view of a suspension section; and

FIG. 3 is a cross-sectional view schematically illustrating the structures of a recording lead unit and a reproducing lead unit.

### DETAILED DESCRIPTION OF THE INVENTION

An embodiment of the present invention will be explained below, with reference to the drawings.

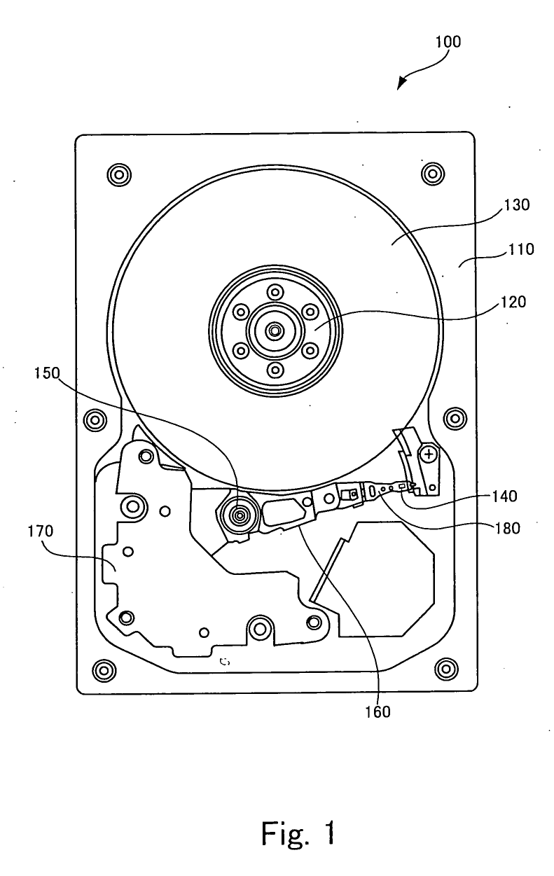

FIG. 1 is a view illustrating an embodiment of the present invention.

A hard disc drive (HDD) 100 illustrated in FIG. 1 corresponds to an embodiment of an information recording apparatus according to the present invention; a housing 110 of the hard disc drive 100 contains a magnetic disc 130 that rotates mounted on a rotation axle 120, a slider 140 equipped with a magnetic head that records information in and reproduces information from the magnetic disc 130, a leaf-spring-like suspension 180 that holds the slider 140, an arm main body 160, with the suspension 180 fixed thereon, that pivotally moves with respect to an arm axle 150, along the top side of the magnetic disc 130, and an arm actuator 170 that drives the arm main body 160. The inner space of the housing 110 is closed by an unillustrated cover. In this situation, the magnetic disc 130 corresponds to an example of an information recording medium according to the present invention; the rotation axle 120 corresponds to an example of a medium holding section according to the present invention; and the arm actuator 170 corresponds to an example of a drive section according to the present invention. In addition, the suspension 180, the arm main body 160, and a lead unit that, as described later, is arranged on the suspension 180 configure an embodiment of a head arm according to the present invention.

FIG. 1 illustrates the head slider 140 situated at the shunting position off the top side of the magnetic disc 130; however, in the case of recording information in and reproducing information from the magnetic disc 130, the arm main body 160 is driven by the arm actuator 170 including a magnetic circuit, thereby the slider 140 is driven toward a space above the top side of the magnetic disc 130 and positioned at a desired track of the rotating magnetic disc 130.

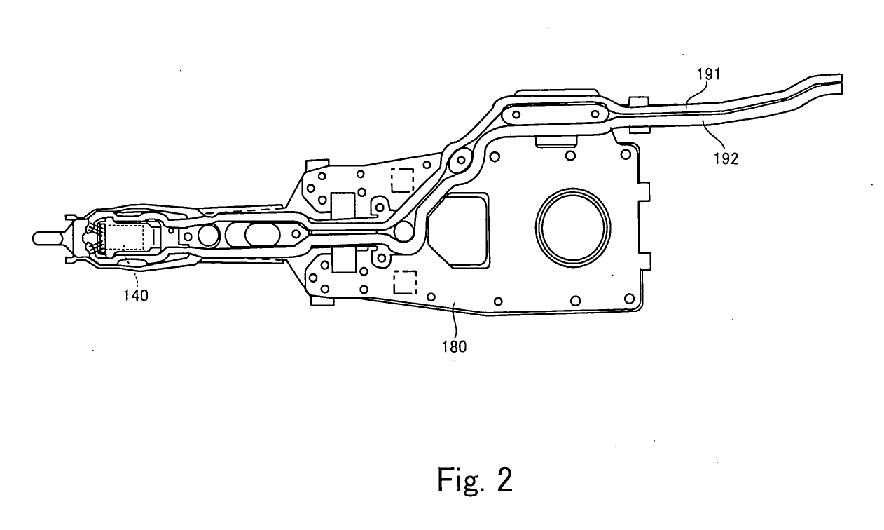

FIG. 2 is an enlarged view of the suspension 180.

The slider 140 is mounted on the vicinity of the front end of the suspension 180; the suspension 180 is formed of an SUS plate and serves as a leaf spring. In addition, a recording lead unit 191 and reproducing lead unit 192 are arranged on the suspension 180; the recording lead unit 191 and reproducing lead unit 192 are electrically connected to the magnetic head mounted on the slider 140.

With rotation of the magnetic disc 130 illustrated in FIG. 1, the magnetic head mounted on the slider 140 subsequently approaches each of microscopic regions along the respective tracks of the magnetic disc 130. In the case where information is recorded, an electrical recording signal is inputted through the recording lead unit 191 to the magnetic head that, as described above, has been situated in the vicinity of the magnetic disc 130, the magnetic head applies magnetic fields to the respective microscopic regions, in accordance with the recording signal, and information carried by the recording signal is recorded as magnetization directions of the respective microscopic regions. In contrast, in the case where information is reproduced, the information recorded as the magnetization directions of the respective microscopic regions is picked up by the magnetic head, as an electric reproduction signal corresponding to the respective magnetic fields created by the magnetizations, and outputted through the reproducing lead unit 192.

The recording lead unit 191 and the reproducing lead unit 192 each have a structure in which, as described later, strip conductors are laminated; the spaces for placing the recording lead unit 191 and the reproducing lead unit 192 are small, and the sizes of the suspension 180 and the head arm are also small.

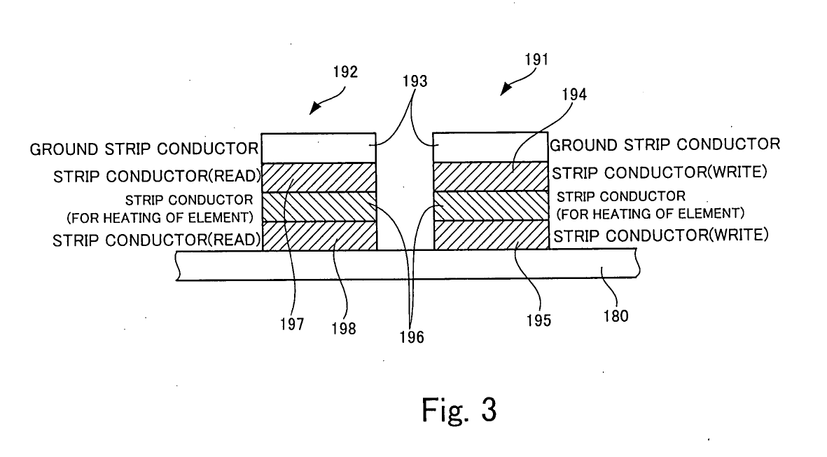

FIG. 3 is a cross-sectional view schematically illustrating the structures of the recording lead unit 191 and the reproducing lead unit 192.

In the present embodiment, in the recording lead unit 191 and the reproducing lead unit 192, respective three-layer strip conductors are provided, as conductive wires through which currents flow. In other words, on the suspension 180, a first strip conductor 198 for reproducing and a first strip conductor 195 for recording are placed; on the first strip conductors 198 and 195, respective heating strip conductors 196 are laminated through which a current for heating the magnetic head flows. Moreover, on the respective heating strip conductors 196, a second strip conductor 197 for reproducing and a second strip conductor 194 for recording are placed that are utilized for transmitting respective differential signals in pairs with the first strip conductors 198 and 195, respectively. When a signal current flows to the magnetic head, through the one of the first strip conductor 198 and the second strip conductor 197, the signal current returns from the magnetic head, through the other of the first strip conductor 198 and the second strip conductor 197; similarly, when a signal current flows to the magnetic head, through the one of the first strip conductor 195 and the second strip conductor 194, the signal current returns from the magnetic head, through the other of the first strip conductor 195 and the second strip conductor 194. On the second strip conductors 197 and 194, respective ground strip conductors 193 are laminated that have the same potential as that of the suspension 180 and through which no signal current flows.

By means of the recording lead unit 191 and the reproducing lead unit 192 having a laminated structure as described above, totally six conductive wires including the heating strip conductors are provided in a compact fashion. Moreover, because the shape of the laminated-structure lead unit is unsusceptible to agitation by a wind, the accuracy of positioning of the magnetic head is high.

In this situation, the suspension 180 corresponds to an example of a metal plate according to the present invention; the first strip conductors 198 and 195 and the second strip conductors 197 and 194 correspond to respective examples of a first signal conductive wire and a second signal conductive wire, respectively, according to the present invention; the heating strip conductor 196 corresponds to an example of a heating conductive wire according to the present invention; the ground strip conductor 193 corresponds to an example of a ground line according to the present invention; and the first strip conductors 198 and 195, the heating strip conductor 196, and the second strip conductors 197 and 194 configure an example of a conductive wire section according to the present invention.

When viewed in the lamination direction (i.e., in the vertical direction in FIG. 3), a pair of the first strip conductors 198 and 195 and a pair of the second strip conductors 197 and 194 are laminated symmetrically with each other with respect to a pair of heating strip conductors 196 interposed between the respective first strip conductors and the respective second strip conductors; therefore, including the suspension 180 and the ground strip conductor 193, the pair of the first strip conductors and the pair of the second strip conductors are also symmetrical with each other, in terms of an electromagnetical environment. Accordingly, the impedance of the first strip conductors 198 and 195 is equal to that of the second strip conductors 197 and 194, whereby the differential signals can accurately be transmitted. Moreover, in the present embodiment, because the conductive wires for recording and the conductive wires for reproducing are separately provided in the respective lead units, the interference between the reproduction signal and the recording signal is avoided, whereby the signals are accurately transmitted. As discussed above, in an HDD according to the present embodiment, because the reproduction signal and the recording signal can accurately be transmitted, high-density recording and high-speed access are realized.

In addition, in the above explanation, as an embodiment of an information storage apparatus according to the present invention, an HDD in which a magnetic head is utilized has been described; however, the present invention may also be applied to an MO drive in which an magneto-optical head is utilized.

Still moreover, in the above explanation, as an example of a metal plate according to the present invention, a suspension made of an SUS plate has been described; however, the metal plate according to the present invention may be a plate made of another metal such as copper or aluminum, or a plate that incorporates portions, in a head arm, excluding the portion that functions as a suspension.

Furthermore, in the above explanation, as an example of a lead unit according to the present invention, a lead unit for recording and a lead unit for reproducing have been described; however, the lead unit according to the present invention may be a lead unit through which both the recording signal and the reproducing signal pass.

Still furthermore, in the above explanation, as an example of a conductive wire section according to the present invention, a conductive wire section in which three strip conductors are laminated has been described; however, the conductive wire section according to the present invention may be a conductive wire section in which two conductive wires are laminated or in which four or more conductive wires are laminated. Moreover, a heating strip conductor is included in the three-layer strip conductor; however, the heating strip conductor is not requisite to the present invention.

What is claimed is:

1. A head arm that, in vicinity or in contact with an information recording medium, holds a head that accesses information on the information recording medium, the head arm comprising:
a metal plate that plays at least part of a role of holding the head; and
a lead unit, provided on the metal plate, that is electrically connected to the head and through which a signal representing the information passes, the lead unit having a conductive wire section, mounted on the metal plate, in which a plurality of conductive wires including a first signal conductive wire through which a current corresponding to the signal heads for the head and a second signal conductive wire through which the current corresponding to the signal returns from the head are laminated and the first signal conductive wire and the second signal conductive wire are situated symmetrically with each other, in the direction of the lamination, and the lead unit having a ground line, situated on the conductive wire section, whose electrical potential is the same as that of the metal plate.

2. The head arm according to claim 1, wherein the head records information in and reproduces information from the storage medium, and
the head further includes, as the lead units, a recording lead unit through which a recording signal representing recording information passes and a reproducing lead unit through which a reproducing signal representing reproducing information passes.

3. The head arm according to claim 1, wherein the head has a function of approaching the information recording medium, by being heated through an electric current, thereby being deformed, and the conductive wire section of the lead unit is configured such that a heating conductive wire through which an electric current for deforming the head passes is laminated interposed between the first signal conductive wire and the second signal conductive wire.

4. An information storage apparatus comprising:
a medium holding section that holds a predetermined information recording medium;
a head that accesses information on the information recording medium;
a head arm that holds a head, in a vicinity or in contact with the information recording medium, the head arm comprising:
a metal plate that plays at least part of a role of holding the head;
a lead unit, provided on the metal plate, that is electrically connected to the head and through which a signal representing the information passes, the lead unit having a conductive wire section, mounted on the metal plate, in which a plurality of conductive wires including a first signal conductive wire through which a current corresponding to the signal heads for the head and a second signal conductive wire through which the current corresponding to the signal returns from the head are laminated and the first signal conductive wire and the second signal conductive wire are situated symmetrically with each other, in the direction of the lamination, and the lead unit having a ground line, situated on the conductive wire section, whose electrical potential is the same as that of the metal plate; and
a drive section that drives the head arm such that the head moves along the top side of the information recording medium.

5. The information storage apparatus according to claim 4, wherein the head records information in and reproduces information from the storage medium, and
the head further includes, as the lead units, a recording lead unit through which a recording signal representing recording information passes and a reproducing lead unit through which a reproducing signal representing reproducing information passes.

6. The information storage apparatus according to claim 4, wherein the head has a function of approaching the information recording medium, by being heated through an electric current, thereby being deformed, and the conductive wire section of the lead unit is configured such that a heating conductive wire through which an electric current for deforming the head passes is laminated interposed between the first signal conductive wire and the second signal conductive wire.
